(19) United States
(12) Patent Application Publication
(10) Pub. No.: US 2012/0120109 A1
(43) Pub. Date: May 17, 2012

(54) APPARATUS AND METHOD FOR PROVIDING IMAGE EFFECT IN MOBILE TERMINAL

(75) Inventor: Seung-Yup LEE, Seoul (KR)

(73) Assignee: SAMSUNG ELECTRONICS CO., LTD., Gyeonggi-Do (KR)

(21) Appl. No.: 13/297,502

(22) Filed: Nov. 16, 2011

(30) Foreign Application Priority Data
Nov. 17, 2010 (KR) 10-2010-0114702

(51) Int. Cl. G09G 5/00

(52) U.S. Cl. 345/647

(57) ABSTRACT

An apparatus and method is provided for providing an image effect in a mobile terminal. An image effect provider applies a wrinkling effect to data upon arrival at an end of the data while the data is shifted by a specific user action. A controller controls the image effect provider to display the data to which the wrinkling effect is applied upon arrival at the end of the data by the specific user action.

### CLAIM OF PRIORITY

This application claims the benefit under 35 U.S.C. §119(a) of a Korean Patent Application filed in the Korean Intellectual Property Office on Nov. 17, 2010 and assigned Serial No. 10-2010-0114702, the entire disclosure of which is hereby incorporated by reference.

### BACKGROUND OF THE INVENTION

1. Field of the Invention

The present invention relates generally to an apparatus and method for providing image effects in a mobile terminal, and more particularly, to an image effect providing apparatus and method for displaying a special effect.

2. Description of the Related Art

A mobile terminal is advanced wireless equipment enabling communication while freely moving around in the coverage of the mobile communication system to which the terminal has subscribed. Such a mobile terminal provides not only communication services but also a variety of value-added services, including on-line games, image/video shooting, and text messaging. Diverse and more data may be stored in the portable terminal due to the prevalence of the value-added services. When the mobile terminal displays data such as pictures stored in a memory, phone numbers stored in a phonebook, and information stored in the recent call list. The user may shift the data by performing a scroll-up/down action to read or view non-displayed portions if the data cannot be fully displayed on a single screen.

Upon arrival at the end of the data while the user shifts the displayed data by the scroll-up/down action to view the remaining non-displayed portions, the data may be no longer shifted, or repeatedly shifted on the same spot, so the user may not easily recognize the data having arrived at its end.

### SUMMARY OF THE INVENTION

An aspect of the present invention provides an image effect providing apparatus and method for displaying a wrinkling effect in which data is wrinkled like paper upon arrival at the end of the data while the data is shifted via a specific user action on the display screen of a mobile terminal.

Another aspect of the present invention provides an image effect providing apparatus and method for displaying a wrinkling effect together with a stretching effect of elastically stretching an image of data upon arrival at the end of the data by a specific user action on the display screen of a mobile terminal.

In accordance with one aspect of the present invention, an apparatus for providing an image effect in a mobile terminal includes: an image effect provider for applying a wrinkling effect to data upon arrival at an end of the data while the data is shifted via a specific user action; and a controller for controlling the image effect provider to display the data to which the wrinkling effect is applied upon arrival at the end of the data.

In accordance with another aspect of the present invention, a method for providing an image effect in a mobile terminal includes: determining whether arrival at an end of data is detected while the data is shifted via a specific user action; and upon arrival at the end of the data, applying a wrinkling effect to the data to indicate the arrival of data end.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating a structure of a mobile terminal according to an embodiment of the present invention;

FIG. 2 is a flowchart illustrating a process of displaying the wrinkling effect upon arrival at the end of data by a scroll-up action in a mobile terminal according to an embodiment of the present invention;

FIG. 3 is a diagram for description of the process shown in FIG. 2;

FIG. 4 is a flowchart illustrating a process of displaying the wrinkling effect upon arrival at the end of data by a scroll-down action in a mobile terminal according to an embodiment of the present invention;

FIG. 5 is a diagram for description of the process shown in FIG. 4;

FIG. 6 is a flowchart illustrating a process of displaying the wrinkling effect upon arrival at the end of data by a flip-up action in a mobile terminal according to an embodiment of the present invention;

FIG. 7 is a diagram for description of the process shown in FIG. 6;

FIG. 8 is a flowchart illustrating a process of displaying the wrinkling effect upon arrival at the end of data by a flip-down action in a mobile terminal according to an embodiment of the present invention;

FIG. 9 is a diagram for description of the process shown in FIG. 8; and

FIGS. 10A and 10B are diagrams illustrating the wrinkling effect upon arrival at the end of data in a mobile terminal according to an embodiment of the present invention.

### DETAILED DESCRIPTION

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

Throughout the drawings, the same drawing reference numerals will be understood to refer to the same elements, features and structures.

The term ‘data’ as used herein may refer to all kinds of data that is stored in a mobile terminal and can be displayed on a display of the mobile terminal, like the picture data and phonebook data.

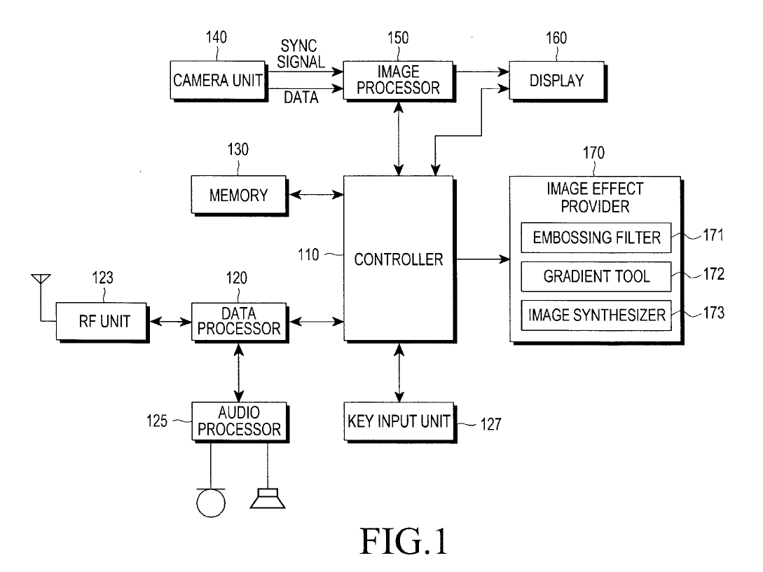

FIG. 1 illustrates a structure of a mobile terminal according to an embodiment of the present invention.

Referring to FIG. 1, a Radio Frequency (RF) unit 123 includes an RF transmitter for frequency-up-converting and amplifying signals to be transmitted, and an RF receiver for low-noise-amplifying and frequency-down-converting received signals. A data processor 120 includes a transmitter for coding and modulating the signals to be transmitted, and a receiver for demodulating and decoding the received signals. To this end, the data processor 120 may include a modem and a codec. The codec includes a data codec for processing packet data, and an audio codec for processing audio signals such as voice. An audio processor 125 plays received audio signals output from the audio codec in the data processor 120 using a speaker SPK, and transfers transmission audio signals picked up by a microphone MIC to the audio codec in the data processor 120.

A key input unit 127 has alphanumeric keys for inputting alphanumeric information, and function keys for setting a variety of functions of the mobile terminal.

A memory 130 may include a program memory and a data memory. The program memory may store programs for controlling the general operations of the mobile terminal, and programs for controlling the mobile terminal to apply and display a wrinkling effect in which data is wrinkled like paper, upon arrival at the end of the data while the data is shifted or scrolled via a specific user action on the screen of a mobile terminal.

A controller 110 controls the overall operation of the mobile terminal.

In accordance with an embodiment of the present invention, the controller 110 may control an image effect provider 170 to apply the wrinkling effect to data being displayed upon arrival at the end of the data while the data is shifted according to a specific user action. The end of the data may include at least one of an upper end, a lower end, a left end, and a right end of the data.

The controller 110 may control the image effect provider 170 to recognize coordinates of a point touched in the specific user action on the screen if the specific user action continues during arrival at the end of the data, and to apply the wrinkling effect with a stretching effect of elastically stretching an image of the data, to the data around the coordinates.

The controller 110 may control the image effect provider 170 to generate a haptic effect while applying the wrinkling effect to the data.

The controller 110 may control the image effect provider 170 to sequentially restore a data image around the coordinates of the touched point, to its original data image if a touch action on the screen corresponding to the specific user action is released.

The specific user action of shifting data on the screen may include a scroll-up/down action, a flip-up/down action to continue a scroll-up/down operation by a single action, and a swipe-left/right action.

If the specific user action is the flip-up/down action, the controller 110 may control the image effect provider 170 to display the stretching effect of elastically stretching an image of the data in a direction corresponding to the flip-up/down action at the end of the data upon arrival at the end of the data.

The controller 110 may control the image effect provider 170 to sequentially restore a data image being displayed to its original data image if a scroll-up/down action occurs after arrival at the end of the data by the flip-up/down action.

A camera unit 140 includes a camera sensor for capturing image data and converting the captured optical signal into an electrical signal, and a signal processor for converting the analog image signal from the camera sensor into digital data. The camera sensor may include a Charge Coupled Device (CCD) or a Complementary Metal-Oxide Semiconductor (CMOS) sensor, and the signal processor may include a Digital Signal Processor (DSP). The camera sensor and the signal processor may be integrated into a single unit, or may be realized separately.

An image processor 150 performs Image Signal Processing (ISP) to display the image signal output from the camera unit 140 on a display 160, and the ISP performs the features such as gamma correction, interpolation, spatial variation, image effects, image scaling, Automatic White Balance (AWB), Automatic Exposure (AE), and Automatic Focus (AF). The image processor 150 may process the image signal output from the camera unit 140 on a frame-by-frame basis, and may output the frame image data depending on the characteristics and size of the display 160. The image processor 150 may include a video codec to compress frame image data displayed on the display 160 using a predetermined method, and restore (or decompress) compressed frame image data to its original frame image data. The video codec may include a Joint Photographic Experts Group (JPEG) codec, a Moving Picture Experts Group 4 (MPEG4) codec, and a Wavelet codec. The image processor 150 is assumed to have an On Screen Display (OSD) function, and may output OSD data according to the size of a displayed screen under control of the controller 110.

The display 160 displays an image signal output from the image processor 150 on a screen, and displays user data output from the controller 110. The display 160 may employ a Liquid Crystal Display (LCD), and in this case, the display 160 may include an LCD controller, a memory capable of storing image data, and an LCD device. When incorporated as a touch screen, the LCD may serve as an input unit. In this case, on the display 160 may be displayed the keys of the key input unit 127.

In accordance with an embodiment of the present invention, the display 160 may display the wrinkling effect upon arrival at the end of the data while the data is shifted according to the specific user action on the screen.

The display 160 may display the wrinkling effect on the screen together with the stretching effect of elastically stretching an image of the data in a direction corresponding to the specific user action at the end of the data.

The display 160 may display the effect of sequentially restoring a data image around coordinates of the touched point to its original data image if a touch action for the specific user action is released.

Upon arrival at the end of the data by the flip-up/down action to continue a scroll-up/down operation, the display 160 may display the stretching effect of elastically stretching an image of the data in a direction corresponding to the flip-up/down action at the end of the data.

The display 160 may display the effect of sequentially restoring a data image being displayed to its original data image, if a scroll-up/down action occurs after arrival at the end of the data by the flip-up/down action.

In accordance with an embodiment of the present invention, the image effect provider 170 applies the wrinkling effect to the data around coordinates of a point touched in the specific user action upon arrival at the end of the data while the data is shifted according to the specific user action.

The image effect provider 170 includes an embossing filter 171, a gradient tool 172, and an image synthesizer 173 for providing the wrinkling effect.

The embossing filter 171 applies a height to a mask for a screen output from the mobile terminal in addition to the data of the mobile terminal. Realizing or applying the height may include outputting a high brightness for convex portions and a low brightness for concave portions.

The gradient tool 172 generates a mask for the wrinkling effect by applying a bending effect to the mask to which the height is applied by the embossing filter 171. The gradient tool 172 forms not only curved shapes but also bent shapes to realize the paper-like texture. A 3-Dimensional (3D) effect may be achieved by applying gradually lower brightness around the most convex portion of the image.

The image synthesizer 173 applies the wrinkling effect to the data by synthesizing the data with the mask for the wrinkling effect upon arrival at the end of the data by the specific user action.

Although the wrinkling effect is displayed by synthesizing the data with the mask for the wrinkling effect in an embodiment of the present invention, the feature of the embossing filter 171 and the feature of the gradient tool 172 may be sequentially applied to the data, if it is needed to apply the wrinkling effect to the data.

In accordance with an embodiment of the present invention, using a specific program capable of elastically stretching an image of the data, the image effect provider 170 may apply the stretching effect of elastically stretching an image of the data in a direction corresponding to the specific user action at the end of the data, while applying the wrinkling effect to the data.

Using a specific program capable of sequentially restoring a data image to its original data image, the image effect provider 170 may apply the effect of sequentially restoring a data image around coordinates of the touched point to its original data image, if a touch action for the specific user action is released.

Upon arrival at the end of the data by the flip-up/down action to continue a scroll-up/down operation, the image effect provider 170 may apply the stretching effect of elastically stretching an image of the data in a direction corresponding to the flip-up/down action at the end of the data.

The image effect provider 170 may apply the effect of sequentially restoring a data image to its original data image, if a scroll-up/down action occurs after arrival at the end of the data by the flip-up/down action.

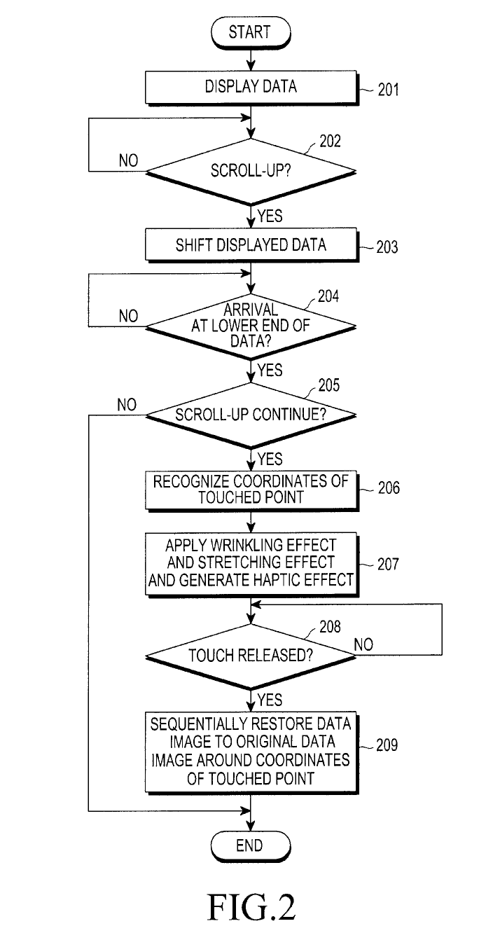

Hereinafter, exemplary operations of displaying the wrinkling effect upon arrival at the end of data in a mobile terminal will be described in detail with reference to FIG. 2 to FIGS. 10A and 10B.

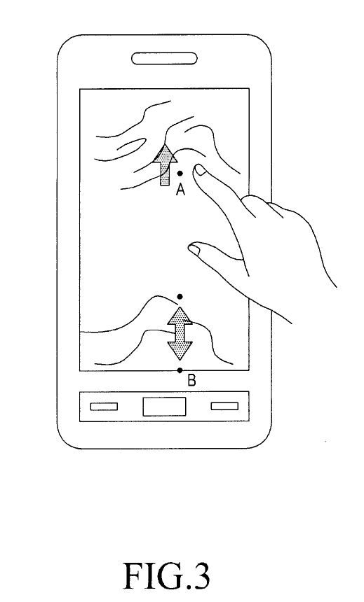

FIG. 2 illustrates a process of displaying the wrinkling effect upon arrival at the end of data by a scroll-up action in a mobile terminal according to an embodiment of the present invention, and FIG. 3 is a diagram for description of the process shown in FIG. 2.

Referring to FIG. 2, while data is displayed on the display 160 of the mobile terminal in step 201, a scroll-up action may occur. Upon detecting the scroll-up action in step 202, the controller 110 shifts the displayed data according to the scroll-up action in step 203.

Upon arrival at the lower end of the data in step 204 while the data is shifted according to the scroll-up action, the controller 110 determines in step 205 whether the scroll-up action continues.

If the scroll-up action continues in step 205 even upon arrival at the lower end of the data, the controller 110 recognizes coordinates of a point touched in the scroll-up action and transfers the recognized coordinates to the image effect provider 170 in step 206.

In step 207, the image effect provider 170 displays the wrinkling effect in which the data around the coordinates is wrinkled like paper, by synthesizing the data with a mask for the wrinkling effect, which is generated by the embossing filter 171 and the gradient tool 172.

When the wrinkling effect is displayed, content such as the picture data and the text data may also undergo the wrinkling effect.

The image effect provider 170 may display the wrinkling effect together with the stretching effect of elastically stretching an image of the data in a direction corresponding to the scroll-up action at the lower end of the data.

The stretching effect of elastically stretching an image of the data is to eliminate any possible spaces which may occur due to the wrinkling effect.

The speed at which an image of the data is elastically stretched may correspond to the speed of the scroll-up action.

The wrinkling effect and the stretching effect are illustrated in FIG. 3, in which upon arrival at the lower end B of the data according to the scroll-up action, the wrinkling effect appears around the coordinates A of the touched point.

In FIG. 3, the wrinkling effect and the stretching effect appear together. The wrinkling effect appears around the coordinates A of the touched point, and the stretching effect appears at the lower end B of the data in a direction corresponding to the scroll-up action.

While the image effect provider 170 displays the wrinkling effect and the stretching effect, the controller 110 may generate a haptic effect and audio data to allow a user to recognize the arrival at the end of the data in a tactile and acoustic way.

If the touch action for the scroll-up action is released in step 208 while the wrinkling effect and the stretching effect are displayed and the haptic effect is generated, the controller 110 restores an image of the data to its original data image in step 209. To be specific, if the controller 110 informs the image effect provider 170 of the release of the touch action, the image effect provider 170 sequentially and naturally restores an image of the data around the coordinates of the touched point to its original data image.

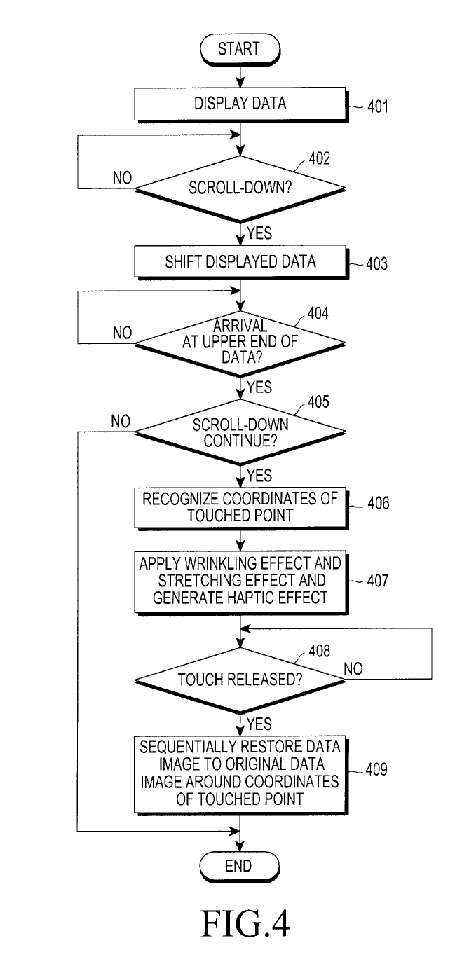

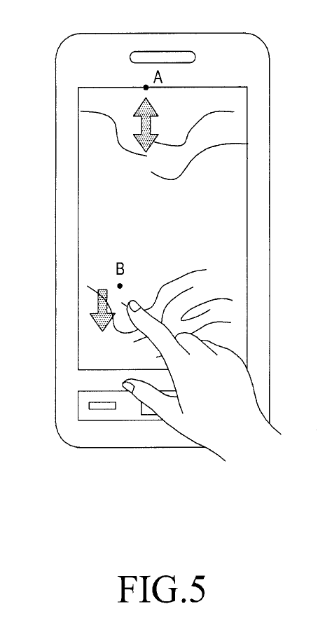

FIG. 4 illustrates a process of displaying the wrinkling effect upon arrival at the end of data by a scroll-down action in a mobile terminal according to an embodiment of the present invention, and FIG. 5 is a diagram for description of the process shown in FIG. 4.

Referring to FIG. 4, while data is displayed on the display 160 of the mobile terminal in step 401, a scroll-down action may occur. Upon detecting the scroll-down action in step 402, the controller 110 shifts the displayed data according to the scroll-down action in step 403.

Upon arrival at the upper end of the data in step 404 while the data is shifted according to the scroll-down action, the controller 110 determines in step 405 whether the scroll-down action continues.

If the scroll-down action continues in step 405 even upon arrival at the upper end of the data, the controller 110 recognizes coordinates of a point touched in the scroll-down action and transfers the recognized coordinates to the image effect provider 170 in step 406.

In step 407, the image effect provider 170 displays the wrinkling effect in which the data around the coordinates is wrinkled like paper, by synthesizing the data with a mask for the wrinkling effect, which is generated by the embossing filter 171 and the gradient tool 172.

When the wrinkling effect is displayed, content such as the picture data and the text data may also undergo the wrinkling effect.

The image effect provider 170 may display the wrinkling effect together with the stretching effect of elastically stretching an image of the data in a direction corresponding to the scroll-down action at the upper end of the data.

The stretching effect of elastically stretching an image of the data is to eliminate any possible spaces which may occur due to the wrinkling effect.

The speed at which an image of the data is elastically stretched may correspond to the speed of the scroll-down action.

The wrinkling effect and the stretching effect are illustrated in FIG. 5, in which upon arrival at the upper end A of the data according to the scroll-down action, the wrinkling effect appears around the coordinates B of the touched point.

In FIG. 5, the wrinkling effect and the stretching effect appear together. The wrinkling effect appears around the coordinates B of the touched point, and the stretching effect appears at the upper end A of the data in a direction corresponding to the scroll-down action.

While the image effect provider 170 displays the wrinkling effect and the stretching effect, the controller 110 may generate a haptic effect and audio data to allow a user to recognize the arrival at the end of the data in a tactile and acoustic way.

If the touch action for the scroll-down action is released in step 408 while the wrinkling effect and the stretching effect are displayed and the haptic effect is generated, the controller 110 restores an image of the data to its original data image in step 409. To be specific, if the controller 110 informs the image effect provider 170 of the release of the touch action, the image effect provider 170 sequentially and naturally restores an image of the data around the coordinates of the touched point to its original data image.

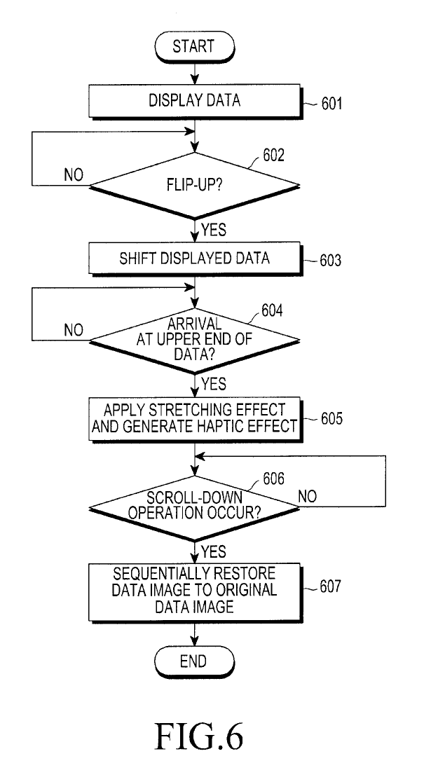

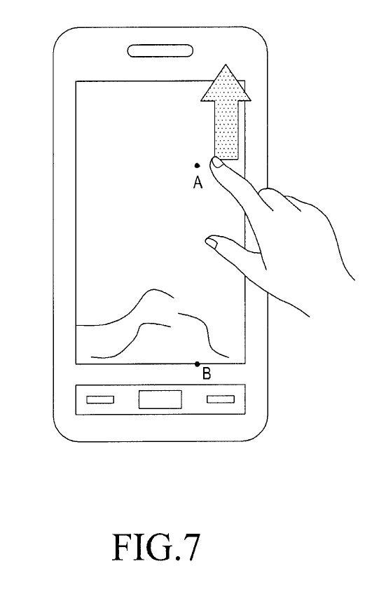

FIG. 6 illustrates a process of displaying the wrinkling effect upon arrival at the end of data by a flip-up action in a mobile terminal according to an embodiment of the present invention, and FIG. 7 is a diagram for description of the process shown in FIG. 6.

Referring to FIG. 6, while data is displayed on the display 160 of the mobile terminal in step 601, a flip-up action may occur. Upon detecting the flip-up action in step 602, the controller 110 shifts the displayed data according to the flip-up action in step 603. The ‘flip-up action’ as used herein may refer to an action to continue a scroll-up operation by a single strong scroll-up action.

Upon arrival at the lower end of the data in step 604 while the displayed data is continuously shifted according to the flip-up action, the controller 110 informs the image effect provider 170 of the arrival at the lower end of the data.

In step 605, the image effect provider 170 displays the stretching effect of elastically stretching an image of the data in a direction corresponding to the flip-up action at the lower end of the data.

When displaying the stretching effect of elastically stretching an image of the data, the controller 110 controls the image effect provider 170 to elastically stretch not only the data image, but also content such as the picture data and the text data.

The speed at which an image of the data is elastically stretched may correspond to the speed of the flip-up action.

The stretching effect is illustrated in FIG. 7, in which upon arrival at the lower end B of the data according to the flip-up action, the stretching effect appears at the lower end B of the data in a direction corresponding to the flip-up action.

While the image effect provider 170 displays the stretching effect, the controller 110 may generate a haptic effect and audio data to allow a user to recognize the arrival at the end of the data in a tactile and acoustic way.

After the arrival at the lower end of the data by the flip-up action, a scroll-down operation may automatically occur.

If a scroll-down operation automatically occurs in step 606 while the stretching effect is displayed and the haptic effect is generated to inform the user of the arrival at the lower end of the data in step 605, the controller 110 restores an image of the data to its original data image in step 607. To be specific, if the controller 110 informs the image effect provider 170 of the occurrence of the scroll-down operation, the image effect provider 170 sequentially and naturally restores an image of the data to its original data image at the speed of the scroll-down operation.

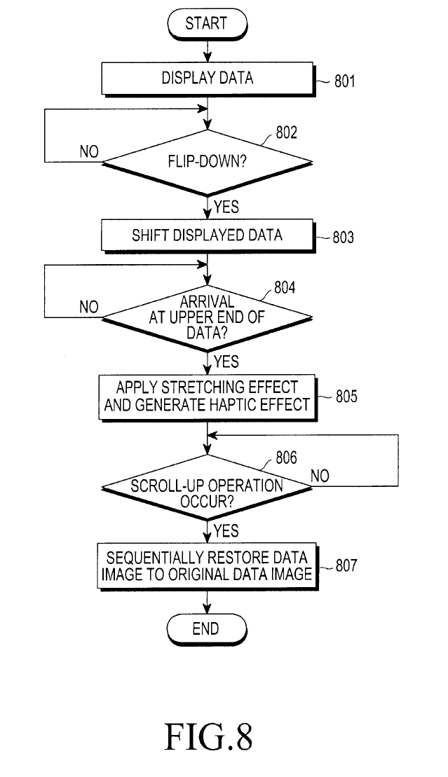

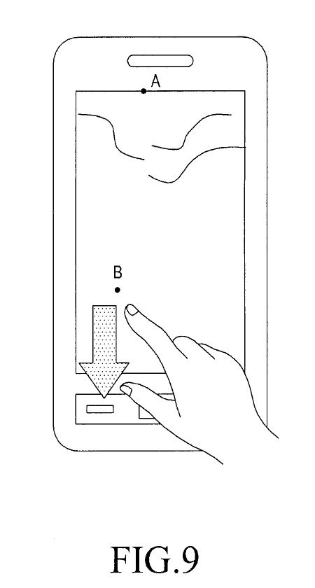

FIG. 8 illustrates a process of displaying the wrinkling effect upon arrival at the end of data by a flip-down action in a mobile terminal according to an embodiment of the present invention, and FIG. 9 is a diagram for description of the process shown in FIG. 8.

Referring to FIG. 8, while data is displayed on the display 160 of the mobile terminal in step 801, a flip-down action may occur. Upon detecting the flip-down action in step 802, the controller 110 shifts the displayed data according to the flip-down action in step 803. The ‘flip-down action’ as used herein may refer to an action to continue a scroll-down operation by a single strong scroll-down action.

Upon arrival at the upper end of the data in step 804 while the displayed data is continuously shifted according to the flip-down action, the controller 110 informs the image effect provider 170 of the arrival at the upper end of the data.

In step 805, the image effect provider 170 displays the stretching effect of elastically stretching an image of the data in a direction corresponding to the flip-down action at the upper end of the data.

When displaying the stretching effect of elastically stretching an image of the data, the controller 110 controls the image effect provider 170 to elastically stretch not only the data image, but also content such as the picture data and the text data.

The speed at which an image of the data is elastically stretched may correspond to the speed of the flip-down action.

The stretching effect is illustrated in FIG. 9, in which upon arrival at the upper end A of the data according to the flip-down action, the stretching effect appears at the upper end A of the data in a direction corresponding to the flip-down action.

While the image effect provider 170 displays the stretching effect, the controller 110 may generate a haptic effect and audio data to allow a user to recognize the arrival at the end of the data in a tactile and acoustic way.

After the arrival at the upper end of the data by the flip-down action, a scroll-up operation may automatically occur.

If a scroll-up operation automatically occurs in step 806 while the stretching effect is displayed and the haptic effect is generated to inform the user of the arrival at the upper end of the data in step 805, the controller 110 restores an image of the data to its original data image in step 807. To be specific, if the controller 110 informs the image effect provider 170 of the occurrence of the scroll-up operation, the image effect provider 170 sequentially and naturally restores an image of the data to its original data image at the speed of the scroll-up operation.

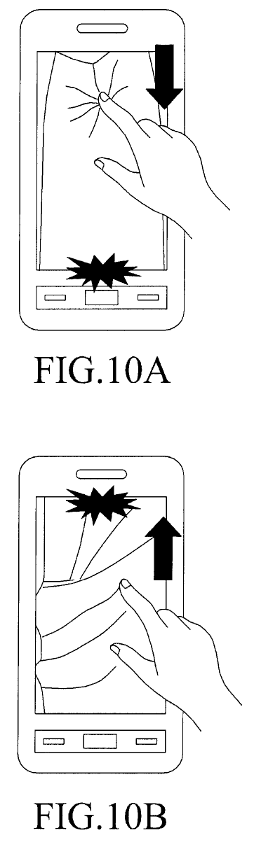

FIGS. 10A and 10B illustrate the wrinkling effect upon arrival at the end of data in a mobile terminal according to an embodiment of the present invention.

FIG. 10A shows the wrinkling effect in which the displayed data is wrinkled around the point touched by the user's finger according to the scroll-down action, while FIG. 10B shows another wrinkling effect in which the displayed data is wrinkled around the point touched by the user's finger according to the scroll-up action. Note that the wrinkling effect displayed during the scroll-down action and the scroll-up action can be displayed interchangeably.

In exemplary embodiments of the present invention, the wrinkling effect and the stretching effect are displayed upon arrival at the end of data while the data is shifted or scrolled by a specific user action, thereby visually informing the user of the arrival at the end of the data.

The wrinkling effect and the stretching effect may be used not only to indicate the arrival at the end of the data, but also to indicate other specific operations or states of the mobile terminal.

For example, if the user takes an action of picking up the displayed data with two fingers, a controller of the mobile terminal may display a message asking the user whether to delete the data, considering the action as a delete action, and delete the data if the user answers by clicking a DELETE icon.

The action of picking up the displayed data with two fingers may be recognized by the controller by detecting an action in which two points spaced apart from each other are simultaneously touched on the display where the data is displayed, and then they gradually get close to each other within a predetermined time.

Although the user can be effectively informed of the arrival at the upper/lower end of data upon arrival at the upper/lower end of the data by the scroll-up/down action or the flip-up/down action in exemplary embodiments of the present invention, the user may be informed of the arrival at the left/right end of the data upon arrival at the left/right end of the data by a swipe-left/right action.

As is apparent from the foregoing description, according to exemplary embodiments of the present invention, the arrival at the end of data may be indicated by the wrinkling effect in a mobile terminal, so a user of the mobile terminal may intuitively recognize the arrival at the end of the data. In addition, the Graphic User Interface (GUI) experience and the haptic/tactile experience may provide the user with analog sensitivity like that of the actual paper, and allow the user to intuitively recognize the positions of data, shifted by a specific user action.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing an image effect in a mobile terminal, comprising:
an image effect provider for applying a wrinkling effect in a screen to indicate an arrival of end of the data while the data is being shifted; and
a controller for controlling the image effect provider to display the data to which the wrinkling effect is applied.

2. The apparatus of claim 1, wherein the image effect provider comprises:
an embossing filter for applying a height effect to a mask for a screen output of the mobile terminal;
a gradient tool for a bending effect to the mask to which the height effect is applied; and
an image synthesizer for applying the wrinkling effect to the data by synthesizing the data with the mask generated by the embossing filter and the gradient tool.

3. The apparatus of claim 1, wherein when applying the wrinkling effect to the data, the image effect provider further applies a stretching effect of elastically stretching an image of the data in a direction corresponding to a specific user action on the screen at the end of the data.

4. The apparatus of claim 1, wherein the image effect provider applies the wrinkling effect to the data around coordinates responsive to a specific user action on the screen.

5. The apparatus of claim 1, wherein the image effect provider sequentially restores a data image around coordinates of a touched point to an original data image thereof when a touch action corresponding to a specific user action on the screen is released.

6. The apparatus of claim 1, wherein the controller recognizes coordinates of a point corresponding to a specific user action on the screen when the specific user action continues during arrival at the end of the data, and controls the image effect provider to apply the wrinkling effect to the data around the coordinates.

7. The apparatus of claim 1, wherein the controller controls the image effect provider to sequentially restore a data image around coordinates of a touched point to an original data image thereof when a touch action corresponding to a specific user action on the screen is released.

8. The apparatus of claim 1, wherein the controller controls the image effect provider to generate a haptic effect while applying the wrinkling effect to the data.

9. The apparatus of claim 1, wherein when a flip-up/down action is detected on the screen, the controller controls the image effect provider to display a stretching effect of elastically stretching an image of the data in a direction corresponding to the flip-up/down action at the end of the data upon arrival at the end of the data.

10. The apparatus of claim 9, wherein the controller controls the image effect provider to sequentially restore a displayed data image to an original data image thereof if a scroll-up/down action occurs after arrival at the end of the data via the flip-up/down action on the screen.

11. The apparatus of claim 1, wherein the end of the data includes at least one of an upper end, a lower end, a left end, and a right end of the data.

12. A method for providing an image effect in a mobile terminal, comprising:
determining whether arrival at an end of data is detected while the data displayed in a screen is being shifted via a specific user action; and
applying a wrinkling effect to the data being displayed upon arrival at the end of the data.

13. The method of claim 12, wherein the applying a wrinkling effect comprises:
upon arrival at the end of the data, determining whether the specific user action on the screen continues;
if the specific user action continues, recognizing coordinates of a point corresponding to the specific user action; and
applying the wrinkling effect to the data around the coordinates.

14. The method of claim 13, wherein the applying the wrinkling effect comprises:
applying a height effect to a mask for a screen output of the mobile terminal;
applying a bending effect to the mask to which the height effect is applied; and
applying the wrinkling effect to the data by synthesizing the data with the mask upon arrival at the end of the data.

15. The method of claim 12, further comprising applying a stretching effect of elastically stretching an image of the data in a direction corresponding to the specific user action on the screen at the end of the data when applying the wrinkling effect to the data.

16. The method of claim 12, further comprising generating a haptic effect when applying the wrinkling effect to the data.

17. The method of claim 12, further comprising sequentially restoring a data image around coordinates of a touched point to an original data image thereof if a touch action corresponding to the specific user action on the screen is released.

18. The method of claim 12, wherein the end of the data includes at least one of an upper end, a lower end, a left end, and a right end of the data.

19. The method of claim 12, wherein the specific user action includes a scroll-up/down action, a flip-up/down action, and a swipe-left/right action.

20. The method of claim 12, further comprising:
when the specific user action is a flip-up/down action to continue a scroll-up/down operation, applying a stretching effect of elastically stretching an image of the data in a direction corresponding to the flip-up/down action upon arrival at the end of the data via the flip-up/down action; and
restoring a displayed data image to an original data image thereof if a scroll-up/down action occurs after arrival at the end of the data via the flip-up/down action.
